(19) United States
(12) Patent Application Publication
(10) Pub. No.: US 2005/0175108 A1
(43) Pub. Date: Aug. 11, 2005

(54) Apparatus and method for playing audio packet stored in a video cd-rom separatedly

(76) Inventor: Tae-Jin Wo, Seoul (KR)

Correspondence Address: Jonathan Y Kang;Lee Hong Degerman Kang & Schmadeka, 801 S Figueroa Street,, 14th floor, Los Angeles,, CA, 90017-5554, US

(21) Appl. No.: 10/509,186

(22) PCT Filed: Mar. 12, 2003
(86) PCT No.: PCT/KR03/00481

(30) Foreign Application Priority Data
Mar. 23, 2002 (KR) 10-2002-0015912

(51) Int. Cl. H04N 11/04

(52) U.S. Cl. 375/240.26

(57) ABSTRACT

Disclosed is a method for playing an audio packet separately in a video CD and apparatus thereof enabling to play the audio packet stored in the video CD selectively as well an MPEG2-formated audio file. In a video CD storing video and audio packets simultaneously, the present invention includes the steps of reading a sector of the video CD, finding packet identification informations from the sector, judging whether the sector includes the audio packet or not using the packet identification informations, decoding the audio packet according to an encoding format if the sector includes the audio packet, and converting the decoded audio packet to an analog signal to output.

### TECHNICAL FIELD

The present invention relates to a method and apparatus for playing an audio packet separately in a video CD, and more particularly, to a method for playing an audio packet separately in a video CD and apparatus thereof enabling to play the audio packet stored in the video CD selectively as well as an MPEG2-formated audio file.

### BACKGROUND ART

Recently, audio data recording media such as CD-ROM, tape, and the like are widely used, and user-demanding music data, study data, and the like are stored in the audio data recording media.

The music data and the like stored in the audio data recording media can be played by an audio equipments such as a CD player and the like.

However, a capacity of the related art audio data recording medium enabling to store the music data and the like therein is not enough to satisfy a user's demand. Hence, a user inconveniently uses a plurality of the audio data recording media.

In order to overcome such an inconvenience, an MP3 file format has been developed. So, the user enables to listen to the music and the like by storing user-demanding MP3 files using an MP3 player enabling to regenerate the MP3 file format.

MPEG (motion picture experts group) is an expanding and compression system of digital audio and video data standardized by ISO (international standardization organization), and can be categorized into MPEG1, MPEG2, etc.

MPEG1 enables to process a digital audio and video stream of 1.5 Mbps, and is suitable for a video player. Audio packets of MPEG1 are classified into layer-1, layer-2, and layer-3. A compression ratio of the layer-1 is generally about 1:4, and a compression ratio of the layer-2 is about 1:6˜1:8. Yet, the layer-3 having an excellent compression ratio of 1:10˜1:12 is called MP3, thereby being widely used.

MPEG2 includes the MPEG1 standard, and is designed to consider a high speed bit rate and a multiple channel.

Namely, MP3 is a music format as a digital file including music therein and is most widely used by normal users. MP3 enables to compress to store the music data of 3˜4 minutes into 2˜5 Mbytes. Hence, a CD-ROM of about 650 Mbytes enables to store the music data amounting to about 14 hours user's listening.

Such a MP3 file can be played using a current user's personal computer or a portable MP3 player, whereby application frequency of the file format increases.

However, the related art MP3 player or CD player has the previously designated file format of the playable music data, whereby other music data having different file formats fail to be played.

Meanwhile, in case of playing a video CD, a video CD player should include an audio output device and a video output device. Hence, it is difficult to play the video CD through portable equipments.

Specifically, in case of a video CD for study or music video, it is demanded that the audio data is played through the portable equipments only.

### DISCLOSURE OF THE INVENTION

Accordingly, the present invention is directed to a method and apparatus for playing an audio packet separately in a video CD that substantially obviates one or more of the problems due to limitations and disadvantages of the related art.

An object of the present invention is to provide a method for playing an audio packet separately in a video CD and apparatus thereof enabling a CD or MP3 player to extract to play the audio packet stored in a CD or MP3 player selectively even if the video CD is inserted in the CD or MP3 player.

Another object of the present invention is to provide a method for playing an audio packet separately in a video CD and apparatus thereof enabling to extract to play the audio packet stored in the video CD, whereby a user has options of playing a video only or both audio and video using the single video CD to promote activation of video CDs.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in a video CD storing video and audio packets simultaneously, a method of playing the audio packet of the video CD separately according to the present invention includes the steps of reading a sector of the video CD, finding packet identification informations from the sector, judging whether the sector includes the audio packet or not using the packet identification informations, decoding the audio packet according to an encoding format if the sector includes the audio packet, and converting the decoded audio packet to an analog signal to output.

Preferably, the step of judging whether the sector includes the audio packet or not using the packet identification information is carried out by judging whether the sector includes the audio packet or not using fields having different values according to kinds of packet data in a plurality of fields of packet headers of the video and audio packets as the packet identification informations.

More preferably, the packet identification informations are field values of stream IDs of the packet headers of the video and audio packets.

Preferably, the audio packet is decoded by MPEG2.

Preferably, the method further includes the step of searching a song stored in the video CD using a front margin, a rear margin, a start code, or/and an end code of the video CD.

To further achieve these and other advantages and in accordance with the purpose of the present invention, in a video CD storing video and audio packets simultaneously, an apparatus for playing the audio packet of the video CD separately includes a CD playing unit reading the video and audio packets stored in the video CD, a data analyzing unit extracting the audio packet only from the video and audio packets read by the CD playing unit, a decoding unit converting the audio packet extracted by the data analyzing unit to an analog audio signal, and an audio outputting unit outputting the analog audio signal, wherein the data analyzing unit selectively extracts the audio packet only using packet identification informations included in all sectors of the video CD.

Preferably, the packet identification informations are field values of stream IDs of packet headers of the video and audio packets.

Preferably, the audio decoding unit decodes the audio packet by MPEG2.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a schematic block diagram of an apparatus for playing an audio packet in a video CD separately according to the present invention;

FIG. 2 illustrates a diagram of a method of extracting an audio packet in a video CD according to one preferred embodiment of the present invention;

FIG. 3 illustrates a diagram of video and audio sectors including an MPEG2 system header;

FIG. 4 illustrates a diagram of MPEG2 video and audio sectors; and

FIG. 5 illustrates a flowchart of a process for playing an audio packet in a video CD according to one preferred embodiment of the present invention.

### BEST MODE FOR CARRYING OUT THE INVENTION

Reference will now be made in detail to the preferred embodiments of the present invention, examples of which are illustrated in the accompanying drawings.

Moreover, for convenience of explanation, an apparatus for playing an audio packet only in video and audio packets stored in a video CD separately is an MP3 player having a CD-ROM inserted therein or a CD player. Of course, any apparatuses enabling to play data stored in the inserted video CD can be applied to the present invention.

Besides, a case that a memory type MP3 player extracts to play an audio packet only from a moving picture MPEG2 data can be within the scope of the present invention.

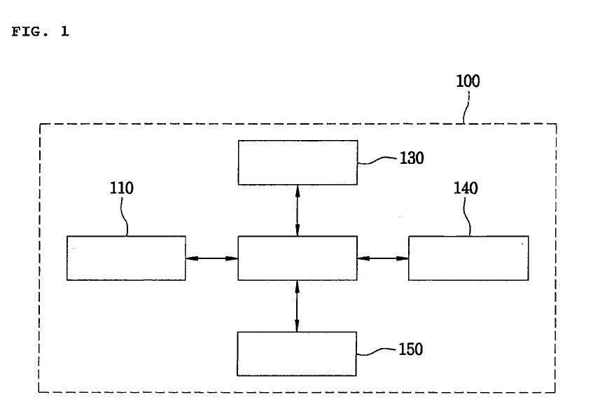

FIG. 1 illustrates a schematic block diagram of an apparatus for playing an audio packet in a video CD separately according to the present invention.

Referring to FIG. 1, an audio packet player 100 includes a CD playing unit 110, a control unit 120, a data analyzing unit 130, an audio decoding unit 140, and an audio output unit 150.

The CD playing unit 110 reads out data stored in a music CD or a video CD (i.e. a recording medium for storing both video and audio packets therein) inputted to the audio packet player. Such a function is commonly included in a general CD player and the like.

An operation of the CD playing unit 110 is explained as follows in brief.

The CD playing unit 110 projects a light beam on each location of a track, and senses an intensity of the reflective light beam to discriminate ‘0’ and ‘1’ of binary data.

The track of a CD includes columns of channel bits leaving a uniform interval from each other. Each of the channel bits enables to have an ON or OFF value. ‘ON’ and ‘OFF’ are realized by a land and a pit, respectively. A reflective wave of the light beam collides with the land is inputted to an optical sensor, and the optical sensor judges that the channel bit is ‘ON’ through the reflective beam. On the other hand, when the projected light beam collides with the pit, a light is dispersed so that the reflective wave fails to be inputted to the optical sensor. And, the optical sensor judges that the channel bit is ‘OFF’. Such fourteen channel bits correspond to data of 8 bits. There is a process of encoding an 8 bit data value into 14 bit channels in the process of mastering, which is called EFM (eight to fourteen modulation).

Namely, the CD playing unit 110 encodes an RF signal read from a disk using an optical pickup for EFM, and corrects it using CIRC (cross interleaved Reed-Solomon code) to restore the original data recorded in the disk.

In order to achieve such an operation, a series of operation controlling an optical pickup device is called ‘servo’ (i.e. a circuit or apparatus for controlling to achieve an optimal phase by feed-back in a stable direction by comparing a phase of a certain device to a reference), and basically includes a focusing control, a tracking control, and a sled control.

Systematically, the CD playing unit includes an optical pickup device and a deck assay having the optical pickup device loaded thereon. The optical pickup device is designed to enable the focusing and tracking controls, and the deck assay is designed to enable the sled control for transferring the pickup device in a radial direction.

The control unit 120 carries out a function of controlling the CD playing unit 110, data analyzing unit 130, audio decoding unit 140, and audio output unit 150 to output the audio data stored in the inserted CD as a form that makes a user audible.

The data analyzing unit 130 carries out a function of selectively extracting an audio packet from the video and audio packets stored in the video CD inserted by the user in accordance with the control of the control unit 120.

A method that the data analyzing unit 130 selectively extracts the audio packet only from the video CD will be explained in detail later by referring to FIG. 2.

The audio decoding unit 140 carries out a function of converting a digital signal of the audio packet detected by the data analyzing unit 130 to an analog signal, and the audio output unit 150 carries out a function of outputting the audio packet converted to the analog signal by the audio decoding unit 140 as an audio form.

The data analyzing and audio decoding units 130 and 140 shown in FIG. 1 enable to be realized as a hardware form (ex. hardware CODEC) or a software form (ex. a software CODEC). When the software form is applied thereto, it is able to support the MPEG2 audio without bearing the cost excessively.

And, although not shown in FIG. 1, the present invention may further include an input unit having buttons and the like enabling a user to select a play mode, a stop mode, and the like of a specific music and a display unit displaying information of a currently played music such as a song title, a playing time, a singer name, etc.

Moreover, in order to apply the present invention to the related art CD player and the like, the software is stored in the built-in ROM and is copied to RAM to install whenever necessary. Hence, it is able to carry out the operation of the software CODEC. And, the present invention further requires no auxiliary equipments, thereby enabling to provide the universality of playing audio data stored in various recording media without bearing the excessive cost.

Besides, by additionally installing ROM for storing the software CODEC or the hardware MPEG2 CODEC in the related art CD player, the present invention enables to provide the universality of playing audio data stored in various recording media without bearing the excessive cost.

FIG. 2 illustrates a diagram of a method of extracting an audio packet in a video CD according to one preferred embodiment of the present invention.

Referring to FIG. 2, schematically shown in a method according to the present invention that the data analyzing unit 130 of the audio packet player 100 selectively extracts to play an audio packet only from a video CD storing audio and video packets therein, an MPEG2 file, or the like.

In the related art, the apparatus for playing both of the video and audio packets should be used to play the video CD and the like. Yet, the audio packet player 100 according to the present invention enables to play an audio packet only regardless of kinds or types of data stored in CD.

A method according to the present invention that the data analyzing unit 130 of the audio packet player 100 selectively extracts to play an audio packet only is explained in detail as follows.

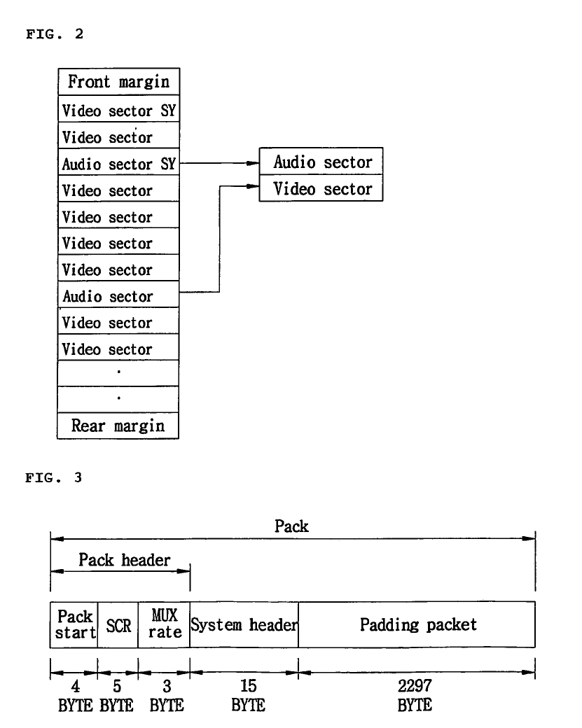

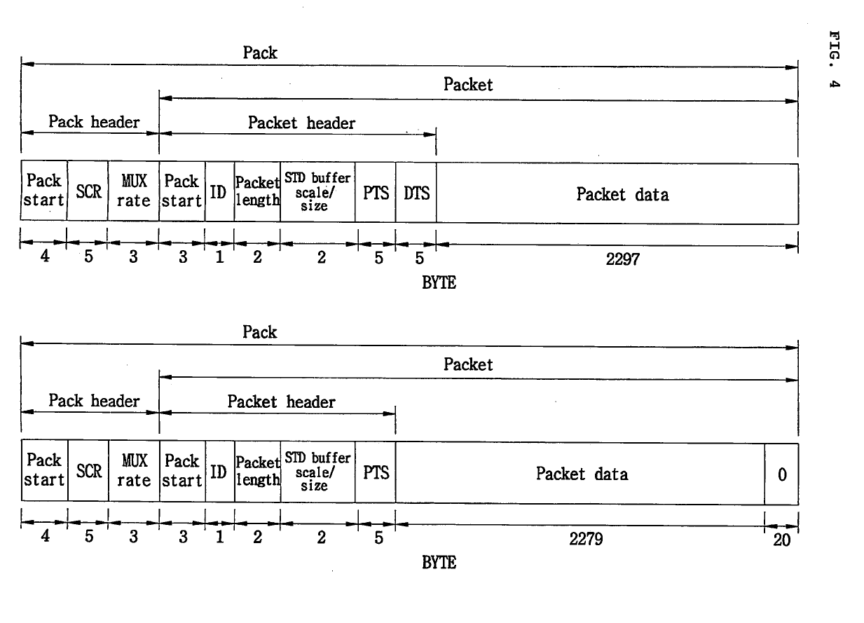

Generally, a video sector including a video packet and an audio sector including an audio packet are alternately located in a video CD. The video and audio sectors located in the most front locations include system headers, respectively. Sectors including system headers, as shown in FIG. 2, are represented by a video packet SY and an audio packet SY, respectively. A structure of a sector including a system header is explained by referring to FIG. 3 as follows.

FIG. 3 illustrates a diagram of video and audio sectors including an MPEG2 system header.

Referring to FIG. 3, a sector is constituted with a single pack. And, the pack includes a pack header, a system header, and a padding packet.

The pack header includes a pack start (pack_start_code), an SCR (system_clock_reference), and a MUX rate. 4 bytes are allocated to the pack start to represent a start of the pack, 5 bytes are allocated to the SCR to represent a system clock reference, and 3 bytes are allocated to the MUX rate.

The system header includes system_header_start_code, rate_bound, audio_bound, fixed_flag, CSPS_flag, system_audio_lock_flag, system_video_lock_flag, video_bound, stream_id, STD_buffer_bound_scale, and STD_buffer_size_bound fields.

In this case, the fields having different values according to the video packet and the audio packet are audio_bound, video_bound, stream_id, STD_buffer_bound_scale, STD_buffer_size_bound, and the like. Hence, the present invention uses the above-explained fields to distinguish the audio sector from the sectors including the system header. Preferably, the present invention distinguishes the audio sector using the stream_id field.

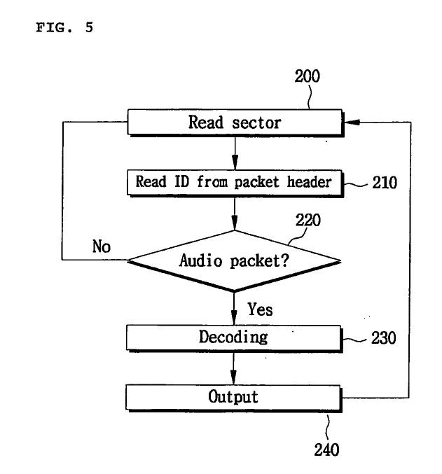

A structure of a genera sector including no system header is explained by referring to FIG. 4. FIG. 4 illustrates a diagram of MPEG2 video and audio sectors.

First of all, a video sector having a video packet includes a pack header, a packet header, and a packet data.

The packet header of the video packet includes packet_start, stream_id, packet_length, STD_buffer_scale/size, PTS (presentation_time_stamp), and DTS (decoding_time_stamp) fields.

An audio sector having an audio packet includes a pack header, a packet header, and a packet data. A zero field of 20 bytes follows an end of the pack. And, the zero field is a field having all bytes of ‘0’.

The packet header of the audio packet includes packet_start, stream_id, packet_length, STD_buffer_scale/size, and PTS (presentation_time_stamp) fields.

The fields having different values in the fields of the audio and video packet headers are the stream_id, STD_buffer_scale/size, and DTS fields. Hence, the present invention uses the above-explained fields to distinguish the audio sector from a plurality of sectors failing to include the system headers. Preferably, the audio sector is distinguished using the stream_id field.

Thus, the audio and video packets stored in the video CD or the like are stored as different forms to be distinguished by the audio packet player 100. And, a method that the audio packet player 100 selectively extracts an audio packet only from data stored in a video CD is explained by referring to FIG. 5 as follows.

FIG. 5 illustrates a flowchart of a process for playing an audio packet in a video CD according to one preferred embodiment of the present invention, in which an example that a video CD is encoded by MPEG2 is shown. And, explanation of FIG. 5 refers to the numerals of FIG. 1.

Referring to FIG. 5, in a step 200, the CD playing unit 110 reads the video or audio sector from the video CD. The read sector is transmitted to the data analyzing unit 130.

In a step 210, the data analyzing unit 130 reads fields a value of the stream-id. If the read sector is a system header, the data analyzing unit 130 reads a field value of the stream_id located between the video_bound and STD_buff_bound_scale fields from the system header. If the reader sector is not the system sector, the data analyzing unit 130 reads a field value of the stream_id located next to the packet-start field from the packet header. Moreover, the data analyzing unit 130 may judge whether the packet included in the transmitted sector is the last packet or not. If the sector having the last packet is detected, the control unit 120 may search a sector in which a start part of a following song is recorded.

In another embodiment of the present invention, in order to discriminate whether the packet included in the read sector is the video or audio packet, it is able to use field values of the audio_bound, video_bound, STF_buffer_bound_scale, and STD_buffer_size_bound can be used for the sector having the system header or it is able to use whether the field value of the STD_buffer_scale/size and the DTS field exist or not for the sector having no system header.

In a step 220, if the field value of the read stream_id is ‘0×C0’, the data analyzing unit 130 judges that the read sector includes the video packet.

If the video packet is read, the playing step returns to the step 200 and then the next sector is read. If the audio packet is read, the read audio packet is transmitted to the audio decoding unit 140.

In the step 220, if the audio packet is transmitted to the audio decoding unit 140, the step 200 can be retrieved to read the next audio packet.

In a step 230, the audio decoding unit 140 decodes the transmitted audio packet into a form enabling to be directly converted to an analog signal using a decoding software or hardware suitable for the encoding format. Assuming that the encoding format is MPEG2, the description of the present invention is explained as follows. When a software decoder is used, the audio decoding unit 140 firstly checks the encoding format of the received audio packet, confirms that the encoding format is MPEG2, and then reads a decoding software stored in ROM and the like in RAM. Thereafter, the audio packet is decoded using a decoding software. The audio packet decoded into a digital audio signal enabling to be directly converted to an analog audio signal like WAV form is transmitted to the audio output unit 150 after having been converted to an analog audio signal through a digital/analog converter (DAC).

In a step 240, the audio output unit 150 outputs the analog audio signal to a speaker or earphone so that a listener enables to hear a sound. Since time information for playing each audio packet is included in each audio sector, the audio packet is outputted to correspond to the included time information. The audio output unit 150 uses an amplifier to amplify the analog audio signal to a magnitude that a user can hear. The amplified analog audio signal is outputted through the speaker or earphone connected to the CD player.

The steps 200 to 240 are repeated until the last audio packet is detected. In case of the audio packet of MPEG2, an end code (ISO_{—}11172_end_code) field of 4 bytes is located between a rear end of the audio pack and the zero field in the last audio packet. Hence, once the end code is detected, the control unit 120 searches the next song to repeat the steps 200 to 240.

Thus, the audio packet extracted by the data analyzing unit 130 is decoded by the audio decoding unit 140 and is outputted by the control of the control unit 120 through the audio output unit 150.

Moreover, the audio packet player 100 according to the present invention enables a user to play the audio data stored in a music CD (i.e. a recording medium storing audio data only) as well as the audio packet only in the video CD. And, when audio packets amounting to several songs exist in the video CD, it is able to play only the audio packet corresponding to a specific song according to the user's selection.

This can be carried out by the same method of playing the audio data of a music CD in the related art CD or MP3 player, and more specifically, is performed by the operations of the CD playing and audio output units 110 and 150 by the control of the control unit 120.

The video and audio packets (hereinafter abbreviated packet) corresponding to a single song are separated from each other by a packet corresponding to another song and front and rear margins. Moreover, one identification information indicating a start of the song is included in a first packet of a plurality of packets corresponding to a single song and the other identification information indicating an end of the song is included in a last packet of a plurality of packets corresponding to the single song. Hence, using the front/rear margins and the song start/end identification information, it is able to search the entire songs recorded in the video CD by the same method of the general search for songs in a general CD.

So far, the audio data player 100 according to the present invention explains the method for selectively extracting to play the audio data from the recording media storing both of the video and audio packets.

In brief, a user inserts the video CD or the like in the audio player 100, the data analyzing unit 130 selectively extracts only the audio packet stored in the video CD in accordance with a user's request. (ex. play button input) to load the extracted audio packet on the buffer memory, the audio decoding unit 140 decodes the loaded audio data into the data form enabling to be outputted through the audio output unit 150, and then the decoded audio data is outputted through the audio output unit 150.

### INDUSTRIAL APPLICABILITY

Accordingly, even if the video CD is inserted in the CD or MP3 player, the present invention enables the CD or MP3 player to extract to play the MPEG2 audio packet stored in the video CD selectively.

Moreover, the present invention selectively extracts to play the audio packet stored in the video CD, whereby a user has options of playing a video only or both audio and video using the single video CD to promote activation of video CDs.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. In a video CD storing video and audio packets simultaneously, a method of playing the audio packet of the video CD separately, comprising the steps of:
reading a sector of the video CD;
finding packet identification informations from the sector;
judging whether the sector includes the audio packet or not using the packet identification informations; decoding the audio packet according to an encoding format if the sector includes the audio packet; and
converting the decoded audio packet to an analog signal to output.

2. The method of claim 1, wherein the step of judging whether the sector includes the audio packet or not using the packet identification information is carried out by judging whether the sector includes the audio packet or not using fields having different values according to kinds of packet data in a plurality of fields of packet headers of the video and audio packets as the packet identification informations.

3. The method of claim 2, wherein the packet identification informations are field values of stream IDs of the packet headers of the video and audio packets.

4. The method of claim 1, wherein the audio packet is decoded by MPEG2.

5. The method of claim 1, further comprising the step of searching a song stored in the video CD using a front margin, a rear margin, a start code, or/and an end code of the video CD.

6. In a video CD storing video and audio packets simultaneously, an apparatus for playing the audio packet of the video CD separately, comprising:
a CD playing unit reading the video and audio packets stored in the video CD;
a data analyzing unit extracting the audio packet only from the video and audio packets read by the CD playing unit;
a decoding unit converting the audio packet extracted by the data analyzing unit to an analog audio signal; and
an audio outputting unit outputting the analog audio signal,
wherein the data analyzing unit selectively extracts the audio packet only using packet identification informations included in all sectors of the video CD.

7. The apparatus of claim 6, wherein the packet identification informations are field values of stream IDs of packet headers of the video and audio packets.

8. The apparatus of claim 6, wherein the audio decoding unit decodes the audio packet by MPEG2.
